(19) United States
(12) Patent Application Publication
(10) Pub. No.: US 2009/0288019 A1
(43) Pub. Date: Nov. 19, 2009

(54) DYNAMIC IMAGE MAP AND GRAPHICS FOR RENDERING MOBILE WEB APPLICATION INTERFACES

(75) Inventor: Brian Tunning, Shanghai (CN)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/121,780

(22) Filed: May 15, 2008

(51) Int. Cl. G06F 3/048; G06F 15/16

(52) U.S. Cl. 715/760; 709/203; 715/764

(57) ABSTRACT

A method and system of generating a graphic display. Initially, a background image is displayed. One or more image containers that specify areas overlaying the background image are defined. Images to be rendered in these image containers are requested from a server. The server dynamically generates the images and transmits them to the client device.

### BACKGROUND

The Internet is fast becoming integral to the way corporations, consumers, and individuals conduct business, communicate, and access information on a daily basis. The Internet evolved by connecting personal computers, servers, and network devices together to effectively form a worldwide, publicly accessible series of interconnected data networks. Typically, a user accesses the Internet through a web browser. The web browser is a piece of software that displays a web page hosted on a website connected to the Internet. The web browser obtains information from the web site and generates the corresponding text, graphics, and video for display to the user. The web browser can also support audio as well. Typically, a web page contains hyperlinks to other web pages. This enables the user to quickly and easily access information provided on related web sites by traversing the hyperlinks.

The Internet has proven to be so popular and useful that wireless devices have been adapted and are now specially designed to be able to connect to the Internet. Cell phones, personal digital assistants, laptops, and all manner of mobile computing devices have built-in displays and web browsers. Users on-the-go can readily access the Internet through a myriad of wireless, mobile computing and communications devices.

Unfortunately, downloading web pages for display on a browser is bandwidth intensive. It may take a long time to download a web page on a wireless device because wireless transmissions typically have relatively slow data rates. The user may have to wait a while for the web page to complete its download.

Furthermore, mobile devices are characterized as being small, lightweight, and inexpensive. To meet these constraints, the processors are not as powerful, memory chips are smaller, and overall computing resources are less than those of traditional desktop PC's. Consequently, it may take some time to process and render a web page for display on a wireless device. Complicated, content-rich web pages can take an inordinate amount of time and computing power to render for display on the web browser. Furthermore, many web pages are interactive in that the user is invited to make inputs, selections, and invoke functions presented on the web page. The display is changed in response to user interaction. This puts a severe strain on a mobile device's rather limited computing resources. Moreover, because the display screen is small, it is imperative that each pixel is rendered accurately. Otherwise, the resulting image can become blurred and degraded in appearance. Further complicating matters is the fact that there exists many different standards and formats for displaying images on mobile devices. This adds complexity in rendering web pages accurately and quickly.

Another drawback is that because rendering web pages is so computing intensive, it can consume a great deal of the mobile device's battery life. A bigger, heavier, and more expensive battery is needed or else time between charges is shortened.

Together, these factors can make it frustrating and even impractical for users to surf the Internet and interact with web pages on their respective wireless, mobile devices.

### SUMMARY

This Summary is provided to introduce a selection of concepts in a simplified form that are further described below in the Detailed Description. This Summary is not intended to identify key features or essential features of the claimed subject matter, nor is it intended to identify key features or essential features of the claimed subject matter, nor is it intended to be used as an aid in determining the scope of the claimed subject matter.

Embodiments of the present disclosure pertain to a method and system for rendering a web application interface. First, a background image common to that web application is downloaded from a server for display. One or more image containers overlaying the background is used to divide the web page into separate sections. A source attribute is associated with each of these image containers. The source attributes identify particular images stored on the server. The client device (e.g., a cell phone) can request the appropriate image from the server by transmitting its source attribute. When the server receives an image request, it dynamically generates the image belonging to that particular source attribute. The image is then transmitted back to the client device and rendered for display in the appropriate image container. Furthermore, an image can contain one or more “hot-spot” areas that function as links which enable users to click on the hot-spots to obtain more information. Thereby, this approach provides a simpler, more elegant mechanism for generating a dynamic, interactive web application interface.

### DESCRIPTION OF THE DRAWINGS

The accompanying drawings, which are incorporated in and form a part of this specification, illustrate embodiments of the invention and, together with the description, serve to explain the principles of the invention:

FIG. 1 shows a flowchart describing the process for rendering a mobile web application.

FIG. 2 shows an example of a mobile web application that can be built according to embodiments of the present disclosure.

FIG. 3 shows an example of an image corresponding to an image container.

FIG. 4 shows a source attribute table.

FIG. 5 is a flowchart describing a client process for generating a mobile web application according to one embodiment of the present disclosure.

FIG. 6 is a flowchart describing a server process for generating a mobile web application according to one embodiment of the present disclosure.

FIG. 7 shows a client/server system for implementing embodiments of the present disclosure.

FIG. 8 shows a web based calendar application that can be generated according to embodiments of the present disclosure.

FIG. 9 shows user navigation of the web based calendar application.

FIG. 10 shows user data displayed in response to the user clicking on a hot-spot area of an image.

### DETAILED DESCRIPTION

Reference will now be made in detail to embodiments of the claimed subject matter, examples of which are illustrated in the accompanying drawings. While the embodiments will be described, it will be understood that the description are not intended to limit the claimed subject matter to these embodiments. On the contrary, the claimed subject matter is intended to cover alternatives, modifications and equivalents, which may be included within the spirit and scope as defined by the appended claims. Furthermore, in the following detailed description, numerous specific details are set forth in order to provide a thorough understanding of the embodiments. However, it will be recognized by one of ordinary skill in the art that the embodiments may be practiced without these specific details. In other instances, well-known methods, procedures, components, and circuits have not been described in detail as not to unnecessarily obscure aspects of the embodiments.

A method and system for an application of dynamic image maps and graphics servers to render a mobile web application interface is disclosed. Mobile computing devices (e.g., cell phones, personal digital assistants, hand helds, etc.) generally have fewer computing resources than a laptop or desktop style computer in terms of CPU, memory, graphics resources, etc. This means that sending a complicated web page to a mobile device for rendering is often not practical. Embodiments of the present disclosure overcome this limitation by breaking up a complicated visual UI at the design stage into a common background image and separate image containers that define geometrical areas overlaying the background. The appropriate images are dynamically generated by a server and downloaded for display in each of the image containers according to source attributes associated with each of the image containers. An image can contain one or more “hot-spot” areas that function as links which enable users to click on the hot-spots to obtain more information. Thereby, this approach provides a mechanism for building a dynamic, interactive mobile web application in a way whereby user interfaces (UI's) with complicated layouts are rendered as easily as simple ones.

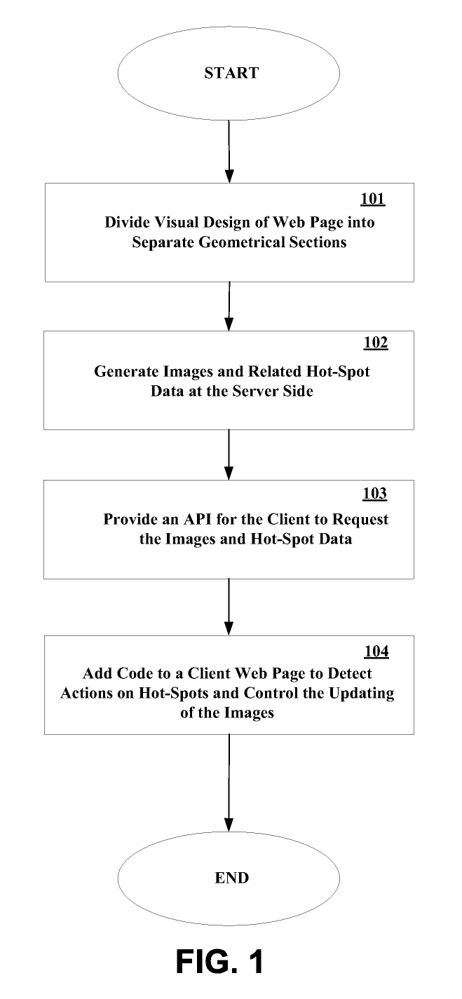

Referring now to FIG. 1, a flowchart is shown that depicts the process for rendering a mobile web application. Initially, in step 101 the visual design of the web page is broken up into geometrical sections. Next, the images and related “hot-spot” data are generated in step 102. A “hot-spot” is defined as an area of the display (e.g., a rectangle or other polygon) that contain events which function as links. The server generates the image dynamically and on-demand. In other words, the server takes no action until it receives a request for an image. When a request is received, the server immediately generates the image and transmits it. In step 103, an application programming interface (API) is provided for the client to request the images and hot-spot data. And in step 104, code is added to a client web page to detect actions on hot-spots and to control the updating of the images.

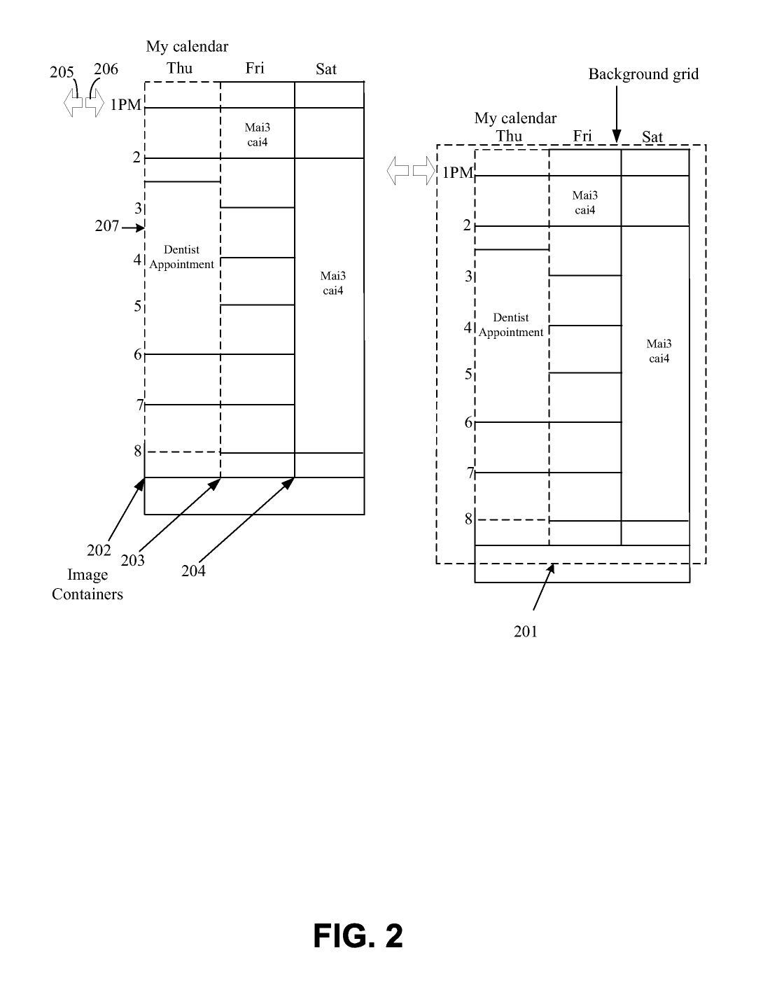

An example of how to make and use a mobile web application according to the above process is now described. FIG. 2 shows a three-day calendar view. Initially, this calendaring user interface is divided into a set of different images. The different images include two arrows 205-206, a single background image 201 and three image containers 202-204. The left arrow 205 and right arrow 206 serve as buttons that can be clicked on. They function as traditional web page links to enable the user to bring up different days on the calendar for display. The background image 201 renders the background lines and the 1 pm, 2 pm, etc. hour list on the left side of the grid. The three image containers 202-204 render the images corresponding to the different days of the week. For example, image container 202 represents Thursday; image container 203 represents Friday; and image container 204 represents Saturday.

When the user first visits the web page, the client application requests the image background 201. The client application also requests 0.gif, 1.gif, and 2.gif to obtain the image containers 202-204 respectively. The 0.gif, 1.gif, and 2.gif are files that contain images in a Graphics Interchange Format (GIF) that correspond to the Thu, Fri, and Sat days of the week. It should be noted that other types of bit map image formats besides GIF can be used to render the background and/or image containers. Upon receipt of the request for 0.gif, the web server does not simply serve up a file from the server's hard disk. Instead, it starts assembling, in real time, an image with data for the logged-in user. The server can use widely available API's, such as Graphics Device Interface (GDI), to create the image. The 0.gif image corresponding to image container 202 or Thu, for example, can have a transparent background with a single square 207 for accepting and displaying text entered by the user. In one embodiment, the hot-spot areas (e.g., square 207) have a different background color or otherwise be highlighted in order to differentiate it from the conventional, non-interactive background. In this example, the user entered “dentist appointment” in the square covering 2:30 pm-6:00 pm on Thu.

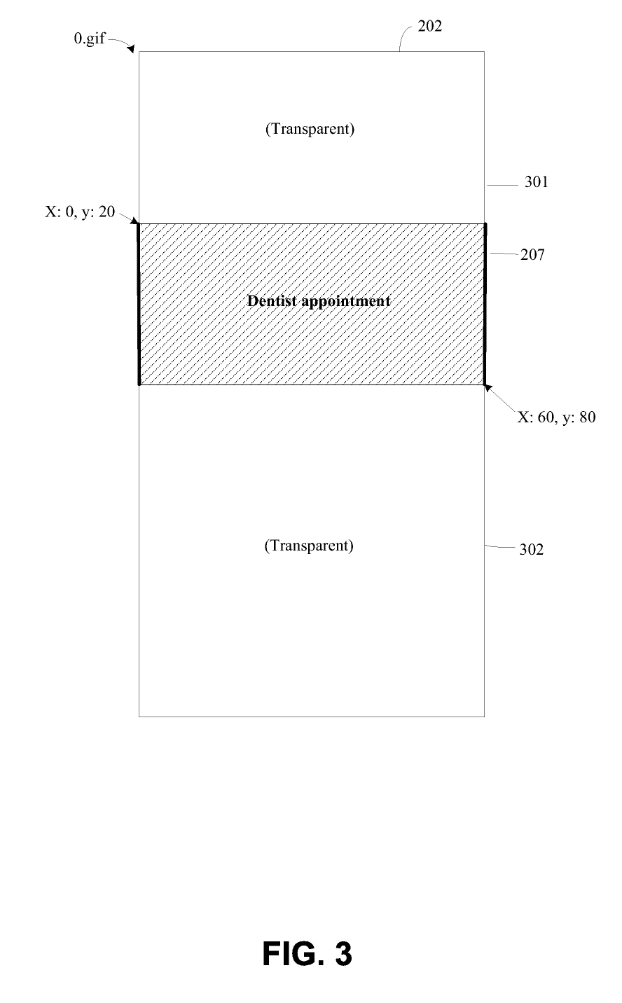

The server renders the square at an offset within the larger image as depicted in FIG. 3. As shown, the 0.gif image container 202 is comprised of a first transparent area 301, square 207, and a second transparent area 302. The area 207 represents a hot-spot. The hot-spot data is the text “dentist appointment.” At the time the server generates the image for this day, it also keeps track of the locations of shapes drawn into the image. The hot-spot's location is defined by its two vertices (x:0, y:20) and (x:60, y:80). The server makes the locations of the squares available in a format that a web page browser can understand. This is commonly referred to as an image map. An example of an image map is shown below:

<img src=“0.giv” usemap=“#green” border=“0”>
<map name=“container A”>
<area shape=“rect” coords=“128, 132, 241, 179”
href=“javascript:handleClick( )”>
</map>

The web application associates the image map to the image using standard techniques. The web application also associates a java script function to handle clicks on shapes within the image. The script differentiates between clicks on a hot-spot (e.g., square 207) and clicks on a conventional non-interactive area (e.g., transparent areas 301 and 302).

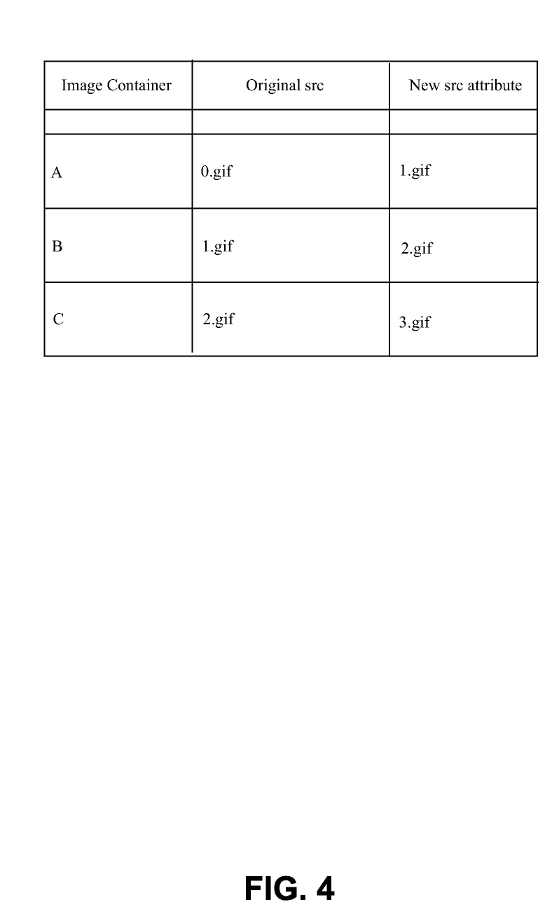

Clicking on a hot-spot causes the application to change the source of one of the images. For example, if the user clicks on the right arrow, the client will change the source (SRC) attribute of the corresponding image containers. FIG. 4 shows how the source attributes are changed in response to clicking on the right arrow. Image container A which had an original SRC attribute of 0.gif will now have a new SRC attribute of 1.gif. Image container B which had an original SRC attribute of 1.gif will now have a new SRC attribute of 2.gif. Image container C which had an original SRC attribute of 2.gif will now have a new SRC attribute of 3.gif. Changing the source attribute of an image causes the web browser to load a new image into the image container. Once an image has been received from the web server, that image is stored locally either on-disk or in a memory cache. Any subsequent request for that particular image is handled by loading the image from the local memory rather than requesting it from the web server. If the image was not previously stored locally, the server generates the new image along with the hot-spot data (if any) and transmits this to the mobile client device. After the new image is loaded into the container, the mobile client device dis-associates the old hot-spot data and associates the new hot-spot data to the correct image container. In this manner, the user can interact with the hot-spot areas of the image even after the image changes.

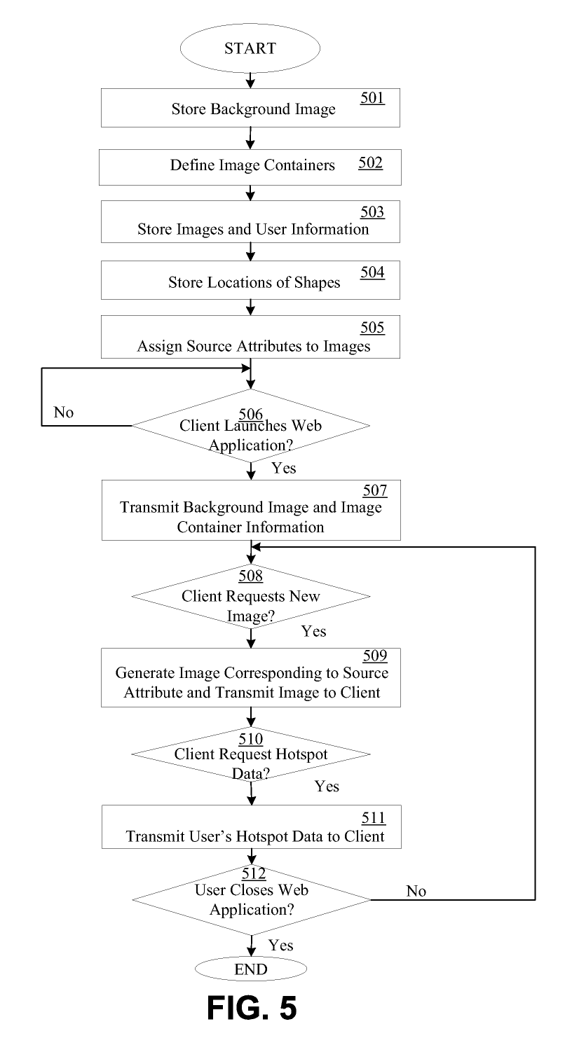

FIG. 5 is a flowchart describing in detail the server process for supporting a mobile web application according to one embodiment. Initially, the server stores a background image associated with a particular mobile web application, step 501. The server can store a number of different background images—one for each mobile web application. The server also defines one or more image containers for each mobile web application, step 502. These image containers specify areas that images are to be displayed by the client device. Image and user information are also stored on the server, step 503. Locations of shapes within an image are stored on the server, step 504. Some shapes are designated as being hot-spot areas. Other shapes are designated as being non-interactive, display-only areas. Source attributes are used to identify the different images. The server contains a list or table that specifies which source attribute is assigned to which one of the images, step 505. The image to be loaded into an image container is given by the source attribute specified for that image container. Consequently, a client device's image container can display different images by simply changing its associated source attribute.

When a client device first launches a mobile web application (step 506), the server transmits the background image and one or more image container information associated with that particular mobile web application to the client device, step 507. If the client device requests a new image, the image being requested is identified by a specific source attribute, step 508. Instead of transmitting a file containing the image information, the server actually generates the image having that specific source attribute and transmits the image to the client device, step 509. Steps 508 and 509 are repeated so that images are displayed in each of the image containers of the client device. If the user wishes to navigate or otherwise interact with the mobile web application, new images can be rendered by the server and displayed in the respective image containers in response to the user's input. This is accomplished by changing source attributes for the image containers and repeating steps 508 and 509. If the user clicks on a hot-spot area (step 510), the server receives a request for data corresponding to that hot-spot. The data can be any type of data (e.g., an image, text, video, graphics, audio, real-time data, streaming data, etc.). In one embodiment, the hot-spot data is personal data pertaining to the subject of that hot-spot. The server transmits the hot-spot data to the client device, step 511. Steps 510 and 511 are repeated each time a user clicks on a hot-spot area. Thereby, the server accepts requests from the client device and responsively transmits images and hot-spot data with minimal overhead and bandwidth. This allows the client device to display complex images while also providing user interactivity with minimal processing. The server continues to monitor client requests until the user chooses to close the mobile web application, step 512.

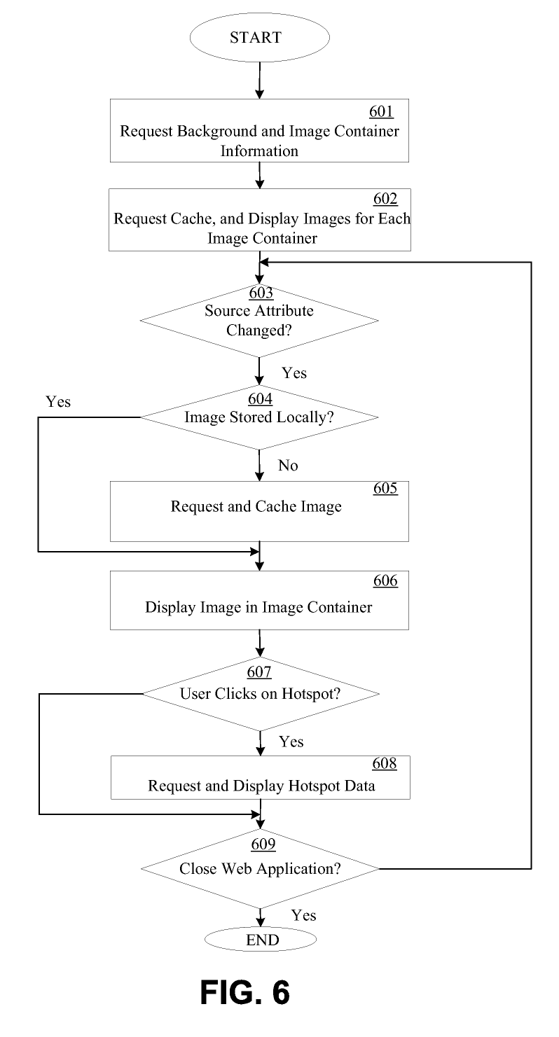

FIG. 6 is a flowchart describing in detail the client process for a mobile web application according to one embodiment. When the user initially launches the mobile web application, a request is sent to the server hosting the information for the background and image container information, step 601. The images corresponding to each of the image containers are also requested from the server, step 602. The received images are cached in the client's local memory so that it can be retrieved quicker next time that particular image is needed. The images are then rendered for display on the screen of the client device. The images are identified according to the respective source attributes corresponding to each of image containers. If the source attribute for an image container is changed, step 603, the new image corresponding to the changed source attribute is displayed in that image container. If the image had previously been cached, it is read out from the client device's local memory and rendered for display, step 606. Otherwise, the new image is requested from the server, step 605. The client device transmits the changed source attribute to identify the new image to the server. The server generates and transmits the new image to the client device. The new image is displayed in its corresponding image container. The overall image can be controllably changed by simply changing one or more source attributes for one or more image containers. Furthermore, parts of the overall image can be reused or moved to a different location by shifting the source attributes from one source container to a different source container. In this manner, the user can navigate, scroll, or otherwise click on arrow buttons to cause different images to load on the client device's web browser.

In one embodiment, an image can contain different areas. Some areas are for display only. Other areas, known as hot-spots, function as links. Clicking on a hot-spot, as determined by step 607, causes the server to serve up the information corresponding to that link. This information is then displayed on the client device's web browser, step 608. The hot-spot data can also be cached in local memory for faster subsequent accesses. Clicking on a hot-spot can also invoke or trigger other events. Thereby, steps 604-608 enable complex images to be displayed while also providing a great deal of user interactivity with minimal processing resources. These steps are repeated until the user closes the web application, step 609.

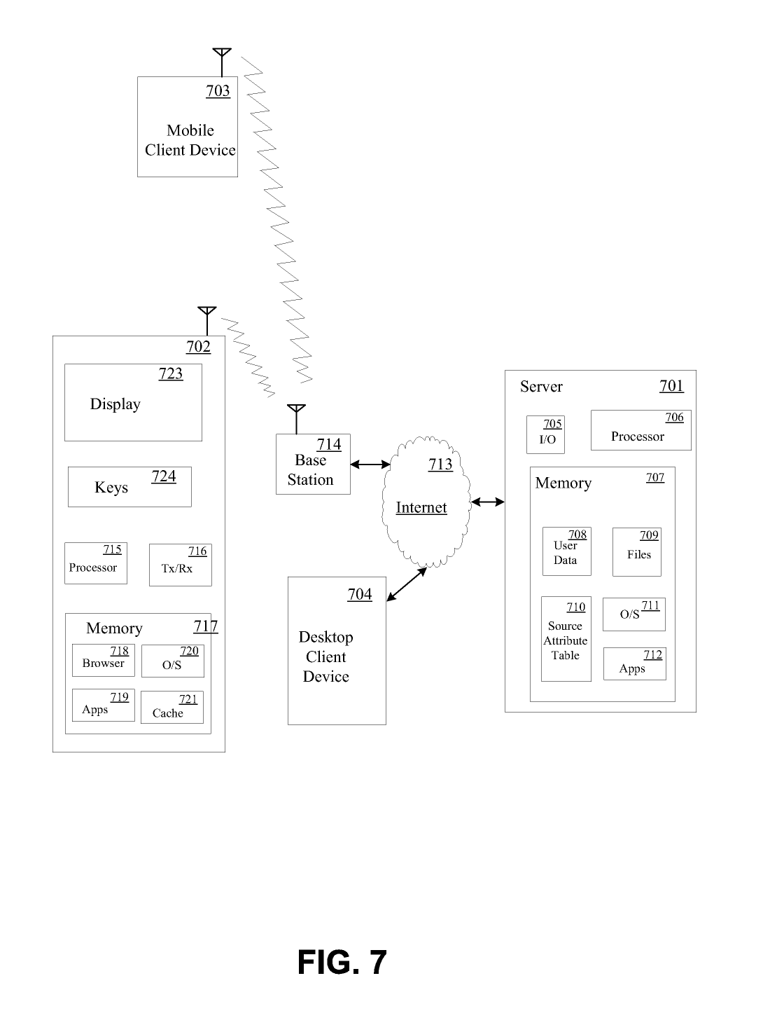

FIG. 7 shows a client/server architecture for supporting a web application embodiment. A server computer 701 acts as a host to a number of client devices 702-704. Client device 702 and 703 can be mobile, wireless, handheld, cellular or some type of battery operated portable device. Although the web application of the present disclosure is particularly suited for web browsers on mobile devices, it can also find utility and offer benefits for traditional web browsers running on standard personal computers (either desktop 704 or laptop). Server 701 includes an input/output (I/O) interface 705 for transmitting and receiving data over the Internet 713. This data is communicated wirelessly through a base station 714, Wi-fi, or some other type of radio frequency (RF) transceiver. Server 701 also includes a processor 706 with executes the applications 712 stored in memory 707. Memory 707 also stores data pertaining to the individual users 708. Users of the web browsers running on the client devices 702-704 will enter and subsequently edit their own specific user data. Certain files are stored in a portion 709 of the memory 707. These files can include backgrounds, image containers, and images for loading into the image containers. These files are transmitted to the client devices 702-704. A source attributes table 710 is used to ensure that the proper image is correctly loaded into the respective image containers. An operating system 711 coordinates the software operations running on server 701.

An exemplary client device system is depicted in 702. The client device typically includes a small display 713. A web browser or some other user interface is displayed. The user can navigate, enter commands and enter data through the web browser or user interface by means of keys 714, touch screen, or some other user input device. The web browser software 718 resides in memory 717. Memory 717 also stores the operating system 717 and the web application along with other types of software applications 719. Memory 717 can also optionally include a cache memory which is used to temporarily store the data (e.g., user data and/or image data) that had previously been received from server 701. The cache memory 721 improves performance and reduces the number of transmissions exchanged between client 702 and server 701. A transceiver 716 is used to transmit requests to server 701 and to received data from server 701.

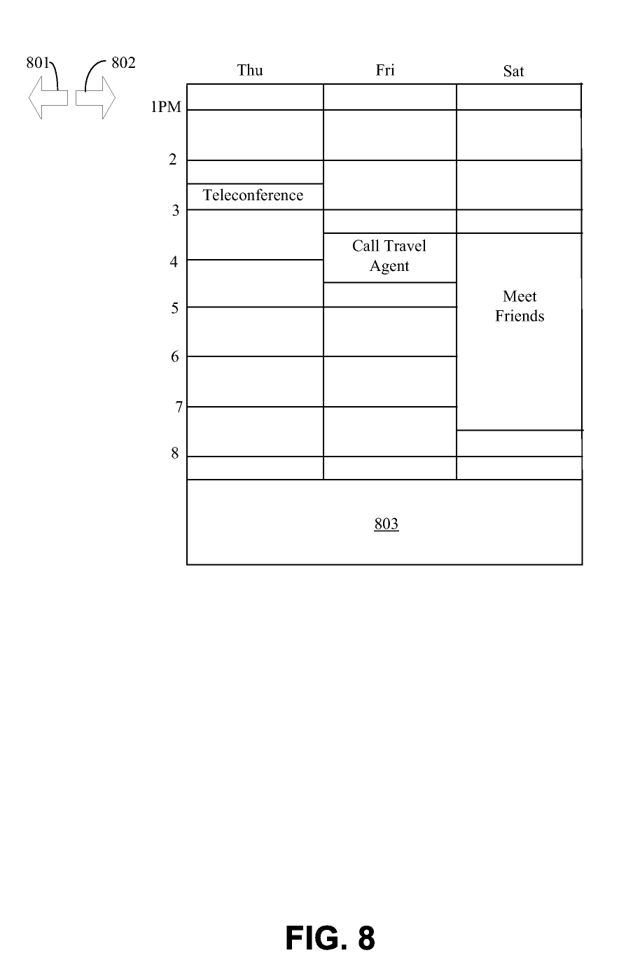

An example of the operation of a mobile web application interface is now described in detail. In this example, the application is a web based calendar. FIG. 8 shows a calendar that is displayed as part of a web browser. The calendar has a background image that was downloaded from the server. The background image includes the grid pattern, the column depicting the hours of the day (1 pm-8 pm), and the left and right arrow buttons 801 and 802. An image container is defined for the columns for each day of the week. In this example, there are three image containers because three days of the week are depicted. A source attribute is associated with each of the image containers. The source attribute for the image container on the left corresponds to an image that includes a hot-spot area. This hot-spot area displays “Teleconference.” The “Teleconference” hot-spot area covers the time slot from 2:30 pm to 3:00 pm. Clicking anywhere on the “Teleconference” hot-spot will cause the user data associated with that particular hot-spot to be displayed in a separate area 803 of the browser. The areas of above and below the “Teleconference” hot-spot are clear, non-interactive displays.

The source attribute associated with the center image container corresponds to an image having a hot-spot labeled as “Call Travel Agent.” The “Call Travel Agent” hot-spot area extends from 3:30 pm to 4:30 pm on Fri. And the source attribute associated with the right image container corresponds to an image having a hot-spot labeled as “Meet Friends.” The “Meet Friends” hot-spot area extends from 3:30 pm to 7:30 pm on Sat. Clicking on either the “Call Travel Agent” or “Meet Friends” hot spots will cause the corresponding user data to be loaded into area 803 of the web browser. Once all three images have been downloaded from the server, they are stored locally in the client device's cache memory.

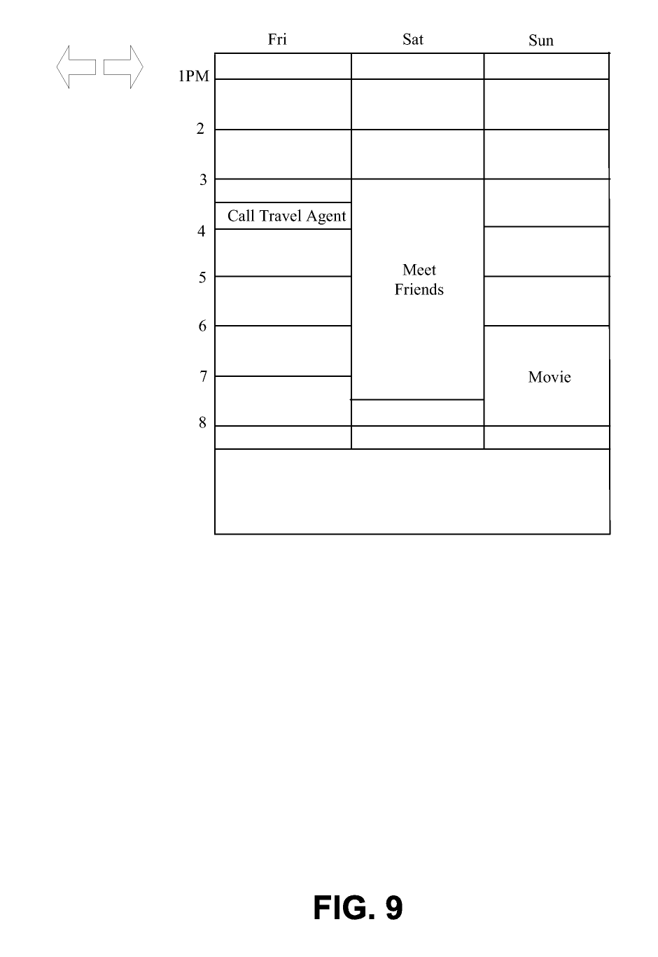

The user can navigate the web calendar by clicking on either the left arrow button 801 or right arrow button 802. Clicking on the left arrow button 801 shifts the calendar one day forward. FIG. 9 shows the web based calendar shifted by one day forward. The left image container now corresponds to Fri; the center image container corresponds to Sat; and the right image container corresponds to Sun. The left image container now has the source attribute corresponding to the image with the “Call Travel Agent” hot-spot. This source attribute had previously been associated with the center image container. Rather than reloading the same image from the server, the image can be retrieved from the cache memory for display. Likewise, the center image container now has the source attribute associated with the image having the “Meet Friends” hot-spot. And because this image was previously stored in the client device's cache memory, it can simply be read from the cache memory for display on the web browser. There is no need to obtain it from the server. The right image container has a new source attribute that corresponds to a new image with a “Movie” hot-spot area that extends from 6:00 pm to 8:00 pm Sat. Since this is a new image, it is requested and downloaded from the server.

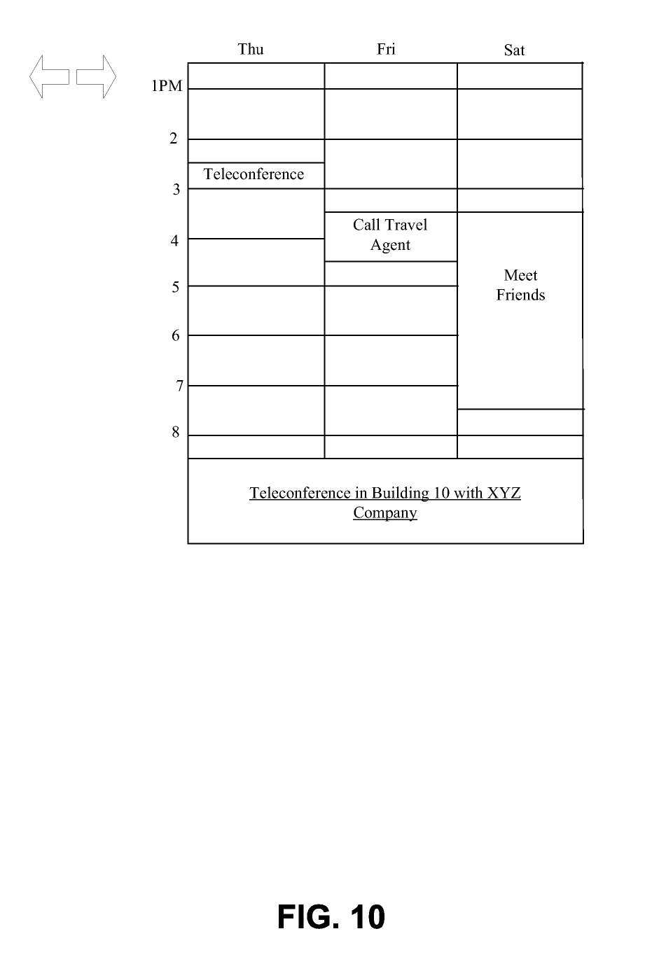

Clicking on the right arrow button 802 at this time causes the calendar to shift backwards by one day. This results in Thu, Fri, and Sat being displayed again. As discussed above, clicking on a hot-spot loads the user data corresponding to that hot-spot. FIG. 10 shows a calendar with user data displayed. For example, if the user clicks on the “Teleconference” hot-spot, it will link the user data which is downloaded from the server and displayed at the bottom. In this example, the user data corresponding to “Teleconference” hot-spot is “Teleconference in Building 10 with XYZ Company.” The user can create new hot-spots and enter or edit the subject as well as the times of the hot-spots. Furthermore, the user can enter or edit the user data for any of the hot-spots.

Thus, a dynamic image map and graphics mechanism to render mobile web application interfaces has been disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of generating a graphic display comprising:
displaying a background image;
defining one or more image containers that specify areas overlaying the background image;
requesting images for each of the image containers from a server;
displaying the images in their respective image containers.

2. The method of claim 1 further comprising:
the server dynamically generating the image in response to a request from a client device.

3. The method of claim 2, wherein the area in the image is defined by an image map.

4. The method of claim 1 further comprising:
defining at least one area in an image, which when selected by a user, causes user information to be displayed.

5. The method of claim 1 further comprising:
caching the images in a local memory.

6. The method of claim 1 further comprising:
associating a particular image with a particular image container by an identifier.

7. The method of claim 6, wherein the identifier comprises a source attribute and changing the source attribute of an image container results in a new image being displayed in that image container.

8. The method of claim 1, wherein the graphic display is rendered on a web browser running on a mobile client device.

9. A method of rendering a web page, comprising:
dividing the web page into a plurality of sections, each of the plurality of sections having an identifier that specifies a particular image;
requesting images from a server for the plurality of sections according to identifiers associated with the plurality of sections;
changing an appearance of the graphic display by changing at least one of the identifiers for one of the sections in response to a user input.

10. The method of claim 9 further comprising:
displaying a background image corresponding to an application corresponding to the web page.

11. The method of claim 9 further comprising:
defining separate areas within an image, wherein a first area is inactive and a second area is responsive to user input.

12. The method of claim 11, wherein clicking on the second area causes the web page to display user information.

13. The method of claim 9 further comprising:
dynamically generating the images when the images are to be rendered for display on the web page.

14. The method of claim 9 further comprising:
reading an image from a local memory.

15. The method of claim 9, wherein the web page corresponds to a web based calendar application.

16. A mobile computing device, comprising:
a display for displaying a user interface that comprises a background and a plurality of images overlaying designated sections of the background image;
a processor coupled to the display that requests the plurality of images from a server device;
a memory coupled to the processor that stores information identifying which image is to be displayed in which of the designated sections.

17. The mobile computing device of claim 16 further comprising:
a user input device coupled to the processor, wherein a user can click on a highlighted area of an image to obtain user data.

18. The mobile computing device of claim 16, wherein the memory stores an image map that identifies the highlighted area.

19. The mobile computer device of claim 16 further comprising a cache memory coupled to the processor, the cache memory used to store images.

20. The mobile computing device of claim 16, wherein the requests cause a remote server device to dynamically generate the images on demand.
